(19) United States
(12) Patent Application Publication
(10) Pub. No.: US 2011/0267586 A1
(43) Pub. Date: Nov. 3, 2011

(54) FOUR-PIECE PROJECTION LENS SYSTEM AND THE PROJECTION APPARATUS USING THE SAME

(75) Inventors: SHANG-AN TSAI, TAIPEI (TW); SAN-WOEI SHYU, TAIPEI (TW)

(73) Assignee: E-PIN OPTICAL INDUSTRY CO., LTD., Taipei (TW)

(21) Appl. No.: 13/053,614

(22) Filed: Mar. 22, 2011

(30) Foreign Application Priority Data
Apr. 30, 2010 (TW) 099114002

(51) Int. Cl. G03B 21/14; G02B 9/34

(52) U.S. Cl. 353/20; 359/650; 353/101

(57) ABSTRACT

A projection apparatus includes a light source emitting an illuminating beam, a light valve receiving the illuminating beam to create an image beam, and a projection lens system arranged on a path of the image beam for receiving and projecting the image beam onto a screen. The projection lens system includes four lens elements arranged along the optical axis in order from the screen toward the light valve, namely, first, second, third and fourth lens elements respectively having positive, negative, positive and positive refractive power. The four-piece projection lens system satisfies the condition of 0.79<BFL/TL<0.99; where, BFL is the back focal length of the projection lens system, and TL is the overall length of the projection lens system on the optical axis from a screen side of the first lens element to a light-valve side of the fourth lens element.

### FIELD OF THE INVENTION

The present invention relates to a four-piece projection lens system for applying to large- and small-sized projectors and slide projection systems. More particularly, the present invention relates to a projection apparatus with a four-piece projection lens system.

### BACKGROUND OF THE INVENTION

In the conventional projection lens for a projector, there are included several lens units, and each of the lens units includes several pieces of lenses. The lens units respectively have a positive or a negative refractive power, an example of which is illustrated in U.S. Pat. No. 7,391,578. While better resolution can be obtained with such projection lens, the large number of lenses thereof would result in an increased overall volume and accordingly, relatively high manufacturing cost of the projector.

For the purpose of combining a projector with a portable electronic device, such as a mobile phone, it necessitates reduction of the projector size. Thus, it is necessary to decrease the number of the projection lenses. However, it is also desirable to obtain good projected image with high resolution while seeking for size-reduced projector. Factors that would affect the resolution and the overall size of the projection lens include the number and the relative position of the lenses, the refractive power and the shape of the lenses, and the like. Among others, the number of the lenses is a key factor. To design a projection lens with good resolution and good modulation transfer function (MTF) effect, one of the means most frequently adopted by the designer is to increase the number of the lenses. This would, however, have adverse influences on the lens size and the manufacturing cost. Therefore, it is always an important issue among the projector designers to reduce the number of lenses and the overall size of projection lens while maintaining good lens resolution.

U.S. Pat. No. 4,690,515 discloses a projection lens having three pieces of lenses, which, in order from the image side, respectively have positive, positive and negative refractive power. U.S. Pat. Nos. 4,564,269 and 4,770,513 both disclose a projection lens having four pieces of lenses, which, in order from the image side, respectively have positive, positive, negative, and negative refractive power; U.S. Pat. No. 4,603,950 discloses a projection lens having four pieces of lenses, which, in order from the image side, respectively have positive, positive, positive, and negative refractive power; and U.S. Pat. No. 7,626,764 discloses a projection lens having four pieces of lenses, which, in order from the image side, respectively have positive, negative, positive, and positive refractive power. While the projection lenses disclosed in the above US patents have reduced number of lenses, the proportion of the projection lens to the light valve or imaging device is still high and the projection field of view is not large enough. Particularly, when a lens with a relatively small projection field of view is employed, it is necessary to increase the distance between the lens and the screen. Under these circumstances, it is difficult to reduce the overall volume of the projector. It is therefore an object of the present invention to overcome the drawbacks of the conventional projection lenses by employing the principle of reducing the back focal distance without sacrificing the projection field of view. With the present invention, it is possible to obtain a projection lens that has reduced size proportion to the light valve and relatively wider projection field of view, and can be combined with a light source, beam splitter and the like to form a projection apparatus. Therefore, the projection lens of the present invention can be applied to large- and small-scale projectors or slide projection systems.

### SUMMARY OF THE INVENTION

A primary object of the present invention is to provide a projection lens system for arranging between a screen and a light valve of a projection apparatus. The projection lens system includes four lens elements arranged along the optical axis in order from the screen toward the light valve, namely, a first, a second, a third and a fourth lens element respectively having positive, negative, positive and positive refractive power. The four-piece projection lens system satisfies the condition of 0.79<BFL/TL<0.99; where, BFL is the back focal length of the projection lens system, and TL is the overall length of the projection lens system on the optical axis from a screen side of the first lens element to a light-valve side of the fourth lens element.

Another object of the present invention is to provide a projection apparatus, which includes a light source for emitting an illuminating beam, a light valve for receiving the illuminating beam to create an image beam, and the above-described projection lens system being arranged on a path of the image beam for receiving and projecting the image beam onto a screen.

With the above arrangements, the projection lens system of the present invention can have an effectively reduced relative length and provide a widened field of view, and enables the projection apparatus of the present invention to have a reduced size.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view showing the optical structure of a projection lens system according to the present invention;

FIG. 2 is a schematic view showing the structure of a projection apparatus according to an embodiment of the present invention;

FIG. 3 is a schematic view showing the optical path structure of the projection lens system of the present invention according to a first embodiment thereof;

FIG. 4 is a field curvature diagram of the projection lens system of FIG. 3;

FIG. 5 is a distortion diagram of the projection lens system of FIG. 3;

FIG. 6 is a longitudinal aberration diagram of the projection lens system of FIG. 3;

FIG. 7 is a schematic view showing the optical path structure of the projection lens system of the present invention according to a second embodiment thereof;

FIG. 8 is a field curvature diagram of the projection lens system of FIG. 7;

FIG. 9 is a distortion diagram of the projection lens system of FIG. 7;

FIG. 10 is a longitudinal aberration diagram of the projection lens system of FIG. 7;

FIG. 11 is a schematic view showing the optical path structure of the projection lens system of the present invention according to a third embodiment thereof;

FIG. 12 is a field curvature diagram of the projection lens system of FIG. 11;

FIG. 13 is a distortion diagram of the projection lens system of FIG. 11;

FIG. 14 is a longitudinal aberration diagram of the projection lens system of FIG. 11;

FIG. 15 is a schematic view showing the optical path structure of the projection lens system of the present invention according to a fourth embodiment thereof;

FIG. 16 is a field curvature diagram of the projection lens system of FIG. 15;

FIG. 17 is a distortion diagram of the projection lens system of FIG. 15;

FIG. 18 is a longitudinal aberration diagram of the projection lens system of FIG. 15;

FIG. 19 is a schematic view showing the optical path structure of the projection lens system of the present invention according to a fifth embodiment thereof;

FIG. 20 is a field curvature diagram of the projection lens system of FIG. 19;

FIG. 21 is a distortion diagram of the projection lens system of FIG. 19; and

FIG. 22 is a longitudinal aberration diagram of the projection lens system of FIG. 19.

### DETAILED DESCRIPTION OF THE PREFERRED EMBODIMENTS

The present invention will now be described in more details with some preferred embodiments thereof by referring to the accompanying drawings.

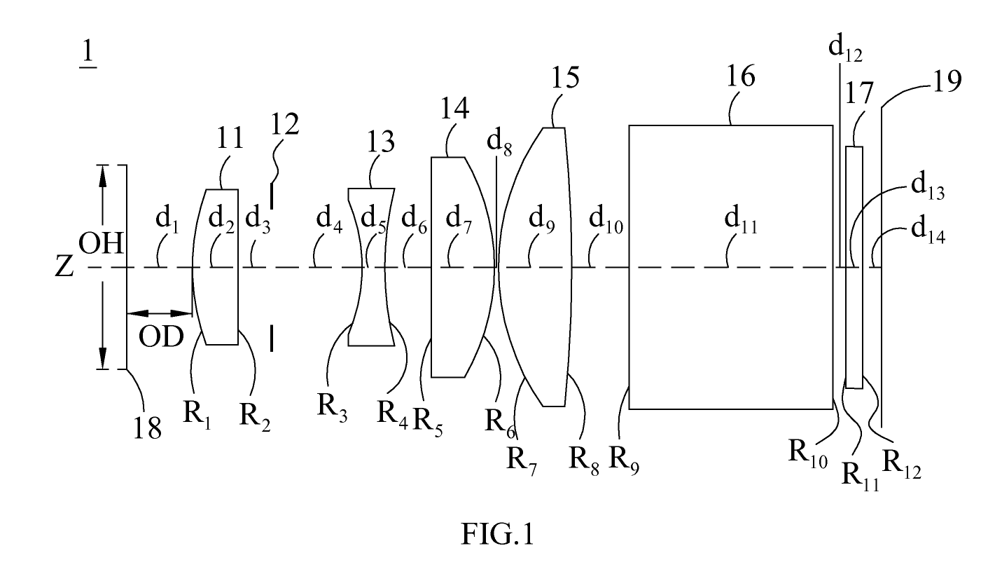

Please refer to FIG. 1 that is a schematic view showing the optical structure of a projection lens system 1 according to the present invention. As shown, the projection lens system 1 includes a first lens element 11, an aperture stop 12, a second lens element 13, a third lens element 14, a fourth lens element 15, a beam splitter 16 and a cover glass 17, sequentially arranged along an optical axis Z from a screen 18 toward a light valve 19.

The first lens element 11 is a planoconvex lens with positive refractive power, and can be made of a glass material or a plastic material having a refractive index (N_{d1}) larger than 1.55 and an Abbe's number (v_{d1}) larger than 61.16. However, it is understood the material for making the first lens element 11 is not restricted to the combination of the refractive index and Abbe's number. The convex surface of the first lens element 11 faces toward the screen 18 while the planar surface of the first lens element 11 faces toward the light valve 19. Moreover, both the convex and the concave surface of the first lens element 11 can be spherical or aspheric, at least one of them is aspheric or both are aspheric.

The aperture stop 12 is an intermediate aperture positioned between the first lens element 11 and the second lens element 13. Alternatively, the aperture stop 12 may be provided on the planar surface of the first lens element 11.

The second lens element 13 is a biconcave lens with negative refractive power, and can be made of a glass material or a plastic material having a refractive index (N_{d2}) larger than 1.70 and an Abbe's number (v_{d2}) larger than 30.05. However, it is understood the material for making the second lens element 13 is not restricted to the combination of the refractive index and Abbe's number. Moreover, both concave surfaces of the second lens element 13 can be spherical or aspheric, at least one of them is aspheric or both are aspheric.

The third lens element 14 is a meniscus lens with positive refractive power, and can be made of a glass material or a plastic material having a refractive index (N_{d3}) larger than 1.59 and an Abbe's number (v_{d3}) larger than 61.16. However, it is understood the material for making the third lens element 14 is not restricted to the combination of the refractive index and Abbe's number. The concave surface of the third lens element 14 faces toward the screen 18 while the convex surface of the third lens element 14 faces toward the light valve 19. Moreover, both the convex and the concave surface of the third lens element 14 can be spherical or aspheric, at least one of them is aspheric or both are aspheric.

The fourth lens element 15 is a biconvex lens with positive refractive power, and can be made of a glass material or a plastic material having a refractive index (N_{d4}) larger than 1.59 and an Abbe's number (v_{d4}) larger than 61.16. However, it is understood the material for making the fourth lens element 15 is not restricted to the combination of the refractive index and Abbe's number. Moreover, both convex surfaces of the fourth lens element 15 can be spherical or aspheric, at least one of them is aspheric or both are aspheric.

In practical application, the projection lens system 1 can be located on an optical path of the beam splitter 16, the cover glass 17 and the light valve 19.

The beam splitter 16 can be a polarization beam splitter (PBS), such as a prism PBS or a wire-grid type PBS, or can be a non-polarization beam splitter. In the case of a polarization beam splitter, only one polarized beam is allowed to pass therethrough while the other polarized beam is reflected therefrom. When the beam splitter 16 is implemented as a prism PBS, it can be made of a glass material having a refractive index (N_{d5}) larger than 1.52 and an Abbe's number (v_{d5}) larger than 33.85. For the purpose of clarity, all the following examples are explained using a prism PBS as the beam splitter thereof. However, it is understood the beam splitter is not restricted to a prism PBS in the present invention.

The light valve 19 serves to create an image beam, and can be a digital micro-mirror device (DMD), a liquid crystal display (LCD), or a liquid crystal on silicon (LCOS) display. For the purpose of clarity, all the following examples are explained using an LCOS display as the light valve thereof. However, it is understood the light valve is not restricted to an LCOS display in the present invention.

The cover glass 17 is a common glass plate and can be made of a glass material having a refractive index (N_{d6}) larger than 1.52 and an Abbe's number (v_{d6}) larger than 63.69. The cover glass 17 is covered on the light valve 19 to protect the same.

The beam splitter 16, the light valve 19 and the cover glass 17 are similar to those being used in the conventional projection apparatus, they are therefore not discussed in details herein.

In projection, the light valve 19 creates an image beam, which sequentially passes through the cover glass 17, the beam splitter 16, the fourth lens element 15, the third lens element 14, the second lens element 13, the aperture stop 12 and the first lens element 11 to project onto the screen 18 and show an image thereon. Further, the projection lens system 1 of the present invention is of a telecentric design with an angle contained between a main beam and the optical axis at the light valve end being smaller than 3°, and can therefore provide the advantage of more uniform brightness distribution, compared to a non-telecentric lens system. Furthermore, the present invention satisfies the conditions as defined by the following inequalities (1) to (7):

0.79<BFL/TL<0.99 (1)

1.47<TL/L_{LV}<1.72 (2)

0.52<OH/OD<0.59 (3)

1.1<f/BFL<1.29 (4)

0.43<f₁/fₛ<0.65 (5)

1.58<N_{dave}<1.65 (6)

53.1<v_{dave}<56.8 (7)

where, BFL is the back focal length of the projection lens system 1; TL is the overall length on the optical axis of the projection lens system 1 from the screen side of the first lens element 11 to the light-valve side of the fourth lens element 15; that is, TL=d₂+d₃+d₄+d₅+d₆+d₇+d₈+d₉; L_{LV} is the effective diagonal line length of the light valve; TL/L_{LV} is the extent of influence of the aperture size of each light valve 19 on the overall length of the projection lens system 1; OH is the image height of the image projected onto the screen 18 by parallel light rays incident upon the projection lens system 1; OD (or d₁) is the distance on the optical axis Z from the screen 18 to the screen side of the first lens element 11; and f is the effective focal length of the projection lens system 1. Moreover, in the present invention, it is also defined that the first lens element 11 is a first lens unit; the second lens element 13, the third lens element 14 and the fourth lens element 15 form a second lens group; f₁ is the focal length of the first lens element 11, and fₛ is the composed focal length of the second lens group. Also, N_{dave} and v_{dave} are defined as the arithmetic means of the average refractive index and the average Abbe's number of the first, the second, the third and the fourth lens element 11, 13, 14 and 15 of the projection lens system 1.

In addition, in the case the beam splitter 16 is implemented as a prism PBS, the projection lens system 1 of the present invention also satisfies the conditions as defined by the following inequalities (8)˜(9):

1.62<N_{dPBS}<1.67 (8)

33.6<v_{dPBS}<64.3 (9)

where, N_{dPBS} and v_{dPBS} are the refractive index and the Abbe's number, respectively, of the prism PBS.

To achieve the objects of the present invention, the optical surfaces (i.e. the surfaces through which the image beam passes) of the first lens element 11, the second lens element 13, the third lens element 14 or the fourth lens element 15 can be spherical or aspheric; and the aspheric surface formula thereof is the following equation (10):

$$Z = \frac{{cr}^{2}}{1 + \sqrt{( 1 - ( 1 + K ) {c}^{2} {r}^{2} )}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16} \qquad ( 10 )$$

where, Z is the distance (SAG) from any point on the lens to the zero point tangential plane of the lens in the direction of optical axis; c is the curvature; r is the lens height; K is the conic constant, and α₁˜α₈ are the 2^{nd}˜16^{th} order aspheric coefficients.

The above structure effectively enables the projection lens system 1 of the present invention to have high resolution while having effectively reduced lens length and widened field of view, allowing the projection lens system of the present invention to have miniaturized size and lowered manufacturing cost.

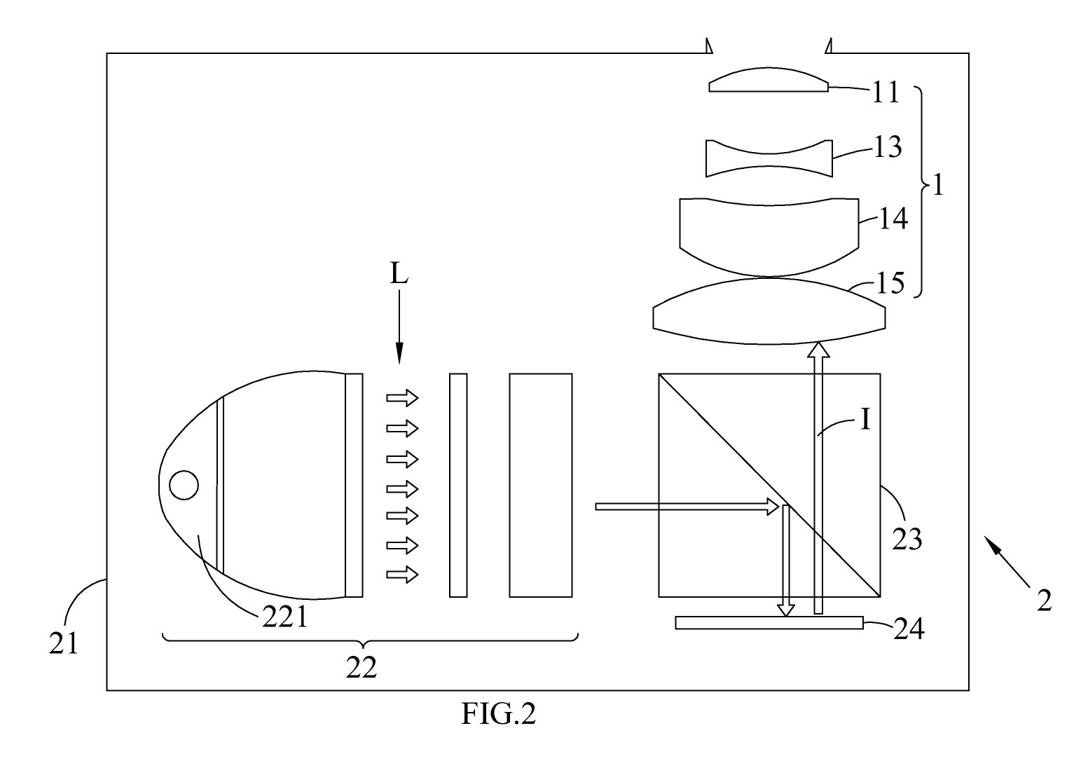

The projection lens system 1 of the present invention can be applied to a projection apparatus 2. Please refer to FIG. 2. The projection apparatus 2 includes an enclosure 21, in which an illuminating system 22, a beam splitter 23, a light valve 24, and the aforesaid projection lens system 1 are arranged. The illuminating system 22 includes a light source 221 for emitting an illuminating beam L. For other different illuminating systems 22, a condensing lens (not shown) can be further provided. The condensing lens is able to condense the light emitted from the light source 221 to the illuminating beam L for increasing the lighting efficiency of the illuminating system 22. Wherein, the light source 221 can include, but not limited to, a high-pressure mercury lamp, a halogen lamp, or a light-emitting diode (LED) lamp.

The beam splitter 23 serves to receive the illuminating beam L and projects the latter to the light valve 24. The beam splitter 23 can be a polarization beam splitter or a non-polarization beam splitter. In the case of the polarization beam splitter, it can be a prism PBS or a wire-grid type PBS. In the case of the polarization beam splitter, only one polarized beam is allowed to pass therethrough while the other polarized beam is reflected therefrom.

The light valve 24 serves to receive the illuminating beam L sent by the beam splitter 23, so that an image beam I is created via the light valve 24. The projection lens system 1 is arranged on a path of the image beam I for receiving the image beam I and then projecting the image beam I onto a screen (not shown) to show the image. The types and the numbers of the illuminating system 22, the beam splitter 23, and the light valve 24 of the projection apparatus 2 according to the present invention are not particularly limited. And, the path of the illuminating beam L is not particularly restricted but can be changed according to actual conditions.

Through the design of the projection apparatus 2 of the present invention and the projection lens system 1 with widened field of view, the projection apparatus 2 can have a reduced size.

The present invention will now be described with some preferred embodiments as below:

### First Embodiment

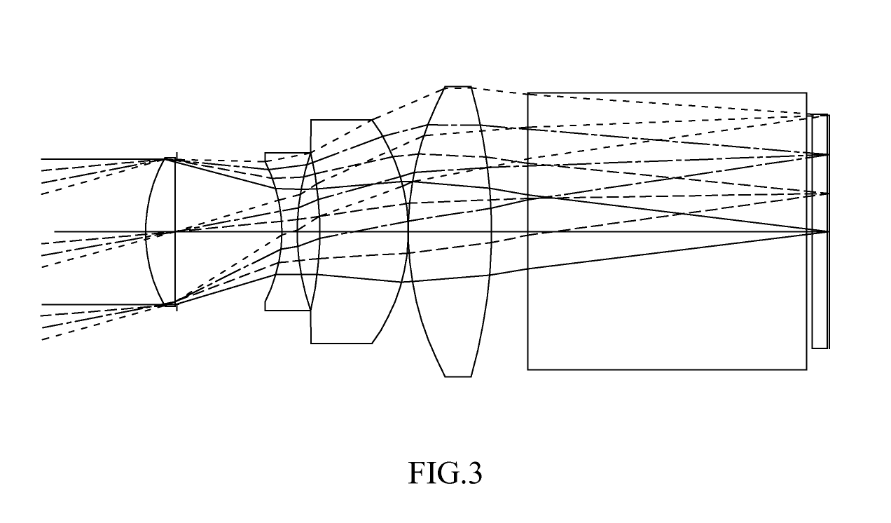

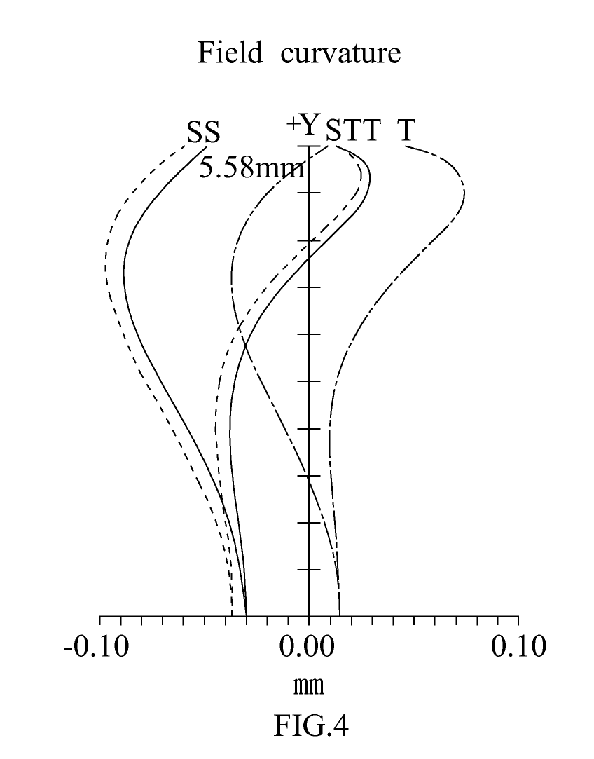

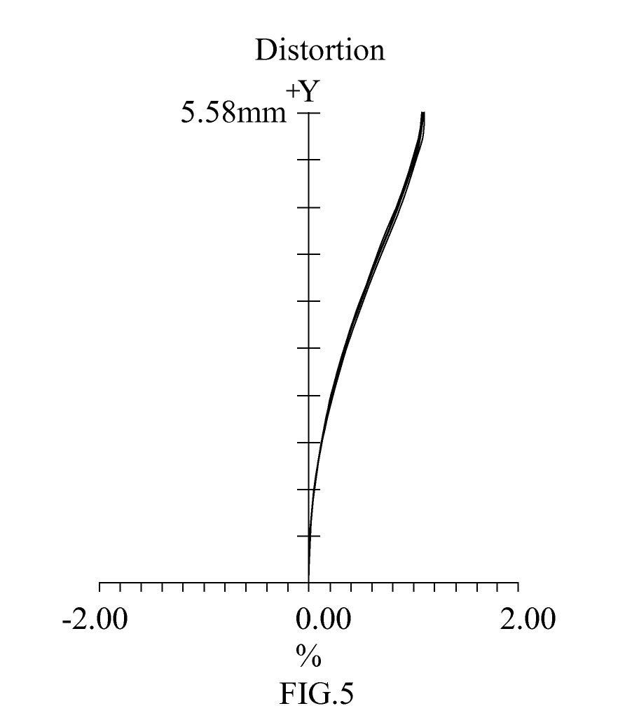

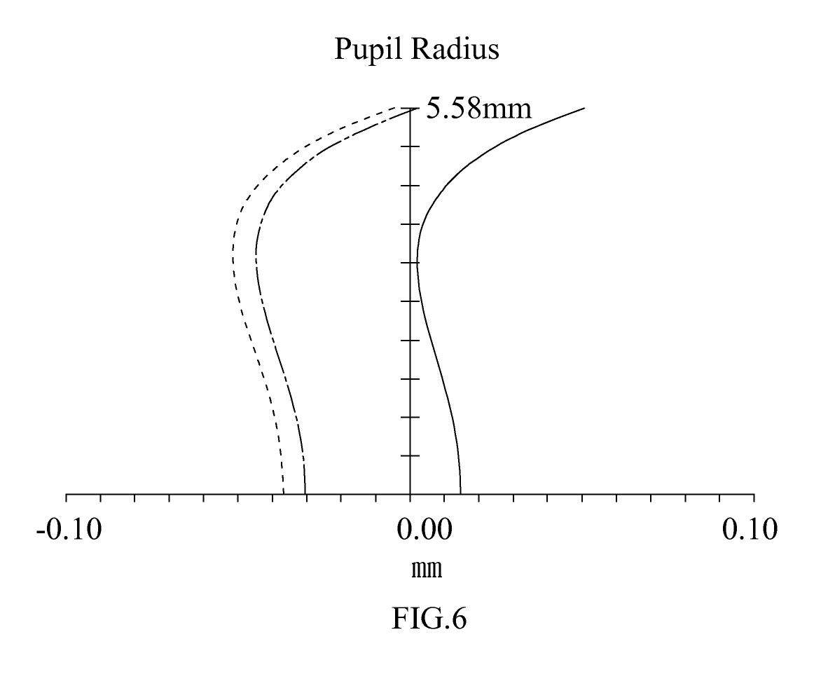

FIG. 3 is a schematic view showing the optical path structure of the projection lens system 1 according to a first embodiment of the present invention; FIG. 4 is a field curvature diagram of the projection lens system 1 in the first embodiment; FIG. 5 is a distortion diagram of the projection lens system 1 in the first embodiment; and FIG. 6 is a longitudinal aberration diagram of the projection lens system 1 in the first embodiment. In these figures, the corresponding vertical axes represent the radius height of the aperture stop.

In the Table 1 listed below, there are shown sequentially numbered optical surfaces from the screen 18 to the light valve 19; the radii of curvature R of these optical surfaces on the optical axis Z in mm; the on-axis surface spacing d between the adjacent optical surfaces on the optical axis Z; the refractive index N_{d} of each of the objects; the Abbe's number (v_{d}) of each the objects; and the effective focal length f, the field of view (FOV), and the f number (Fₙₒ) of the projection lens system 1.

TABLE 1
Optical Parameters in the First Embodiment
f = 20.138 FOV = 30.5312 Fno = 2.831

| | | | Spacing d | Refractive | Abbe's |
|---|---|---|---|---|---|
| Optical surface | | Radius R | (mm) | index N_{d} | number ν_{d} |
| 1 | SCREEN | ∞ | 605.000 | | |
| 2 | R1 | 9.170 | 1.600 | 1.60 | 65.44 |
| 3 | R2 | ∞ | 0.100 | | |
| STOP | | ∞ | 5.660 | | |
| 4 | R3 | −8.145 | 0.720 | 1.71 | 30.24 |
| 5 | R4 | 11.360 | 1.050 | | |
| 6 | R5 | −25.830 | 5.100 | 1.60 | 65.44 |
| 7 | R6 | −9.700 | 0.025 | | |
| 8 | R7 | 19.410 | 4.300 | 1.60 | 65.44 |
| 9 | R8 | −19.410 | 3.195 | | |
| 10 | R9 | ∞ | 13.500 | 1.65 | 33.85 |
| 11 | R10 | ∞ | 0.250 | | |
| 12 | R11 | ∞ | 0.750 | 1.52 | 63.69 |
| 13 | R12 | ∞ | 0.100 | | |
| 14 | IMA | ∞ | | | |

All the above lenses are spherical lenses.

Please refer to FIGS. 3 through 6 and Table 1 along with FIG. 1. In the first embodiment of the projection lens system 1, the effective focal length f is 20.138 mm, the back focal length BFL is 17.795 mm, the diagonal line length of the light valve L_{LV} is 11.176 mm, TL is 18.555 mm, OH is 331.085 mm, and OD is 605 mm. The focal length F₁ of the first lens element 11 is 15.207 mm, and the composed focal length fₛ of the second lens group is 23.996 mm. The average refractive index N_{dave} and the average Abbe's number v_{dave} of the first lens element 11, the second lens element 13, the third lens element 14, and the fourth lens element 15 are 1.63 and 56.64, respectively. The refractive index N_{dPBS} and the Abbe's number v_{dPBS} of the PBS are 1.65 and 33.85, respectively.

After calculation, the values of the inequalities (1)˜(9) obtained from the first embodiment of the projection lens system 1 are shown in the following Table 2. As can be seen from Table 2, the projection lens system 1 in the first embodiment thereof satisfies the conditions defined by the inequalities (1)˜(9).

TABLE 2
Values of the Inequalities (1)~(9)
Obtained from the First Embodiment

| | |
|---|---|
| BFL/TL | 0.96 |
| TL/L_{LV} | 1.66 |
| OH/OD | 0.55 |
| f/BFL | 1.13 |
| f₁/fₛ | 0.63 |
| N_{dave} | 1.63 |
| ν_{dave} | 56.64 |
| N_{dPBS} | 1.65 |
| ν_{dPBS} | 33.85 |

In addition, the projection lens system 1 of the first embodiment can be applied to a projection apparatus 2 shown in FIG. 2. In this embodiment, the projection apparatus 2 includes an enclosure 21, in which an illuminating system 22, a beam splitter 23, a light valve 24, and the projection lens system 1 in the first embodiment are arranged. The illuminating system 22 includes a light source 221 for emitting an illuminating beam L. For other different illuminating systems 22, a condensing lens (not shown) can be further included. With the condensing lens, the light emitted from the light source 221 can be condensed into the illuminating beam L for increasing the lighting efficiency of the illuminating system 22. Wherein, in this first embodiment, the light source 221 is an LED lamp, the beam splitter 23 is a PBS, and the light valve 24 is an LCOS (liquid crystal on silicon) display.

By analyzing FIG. 3, the field curvature diagram (FIG. 4), the distortion diagram (FIG. 5), and the longitudinal aberration diagram (FIG. 6), it is ascertained the first embodiment has effectively reduced the relative length of the projection lens system and provides widened field of view, and also enables the projection apparatus of the present invention to have a reduced size.

### Second Embodiment

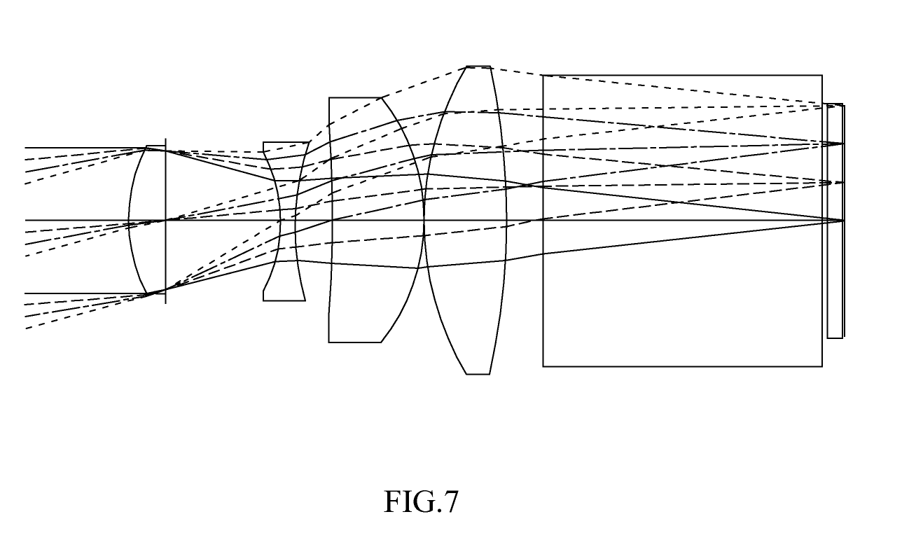

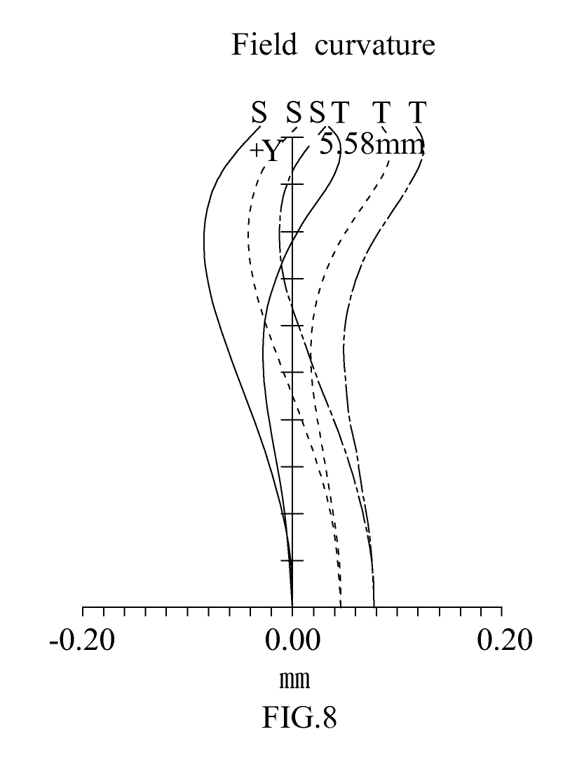

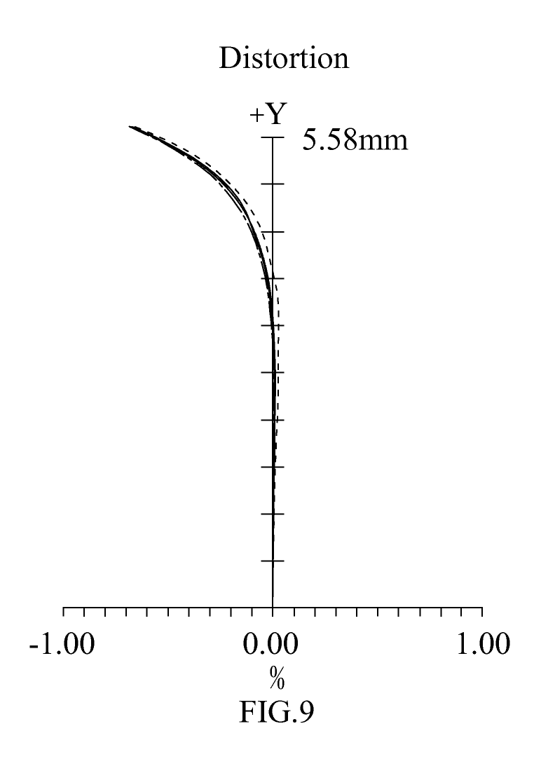

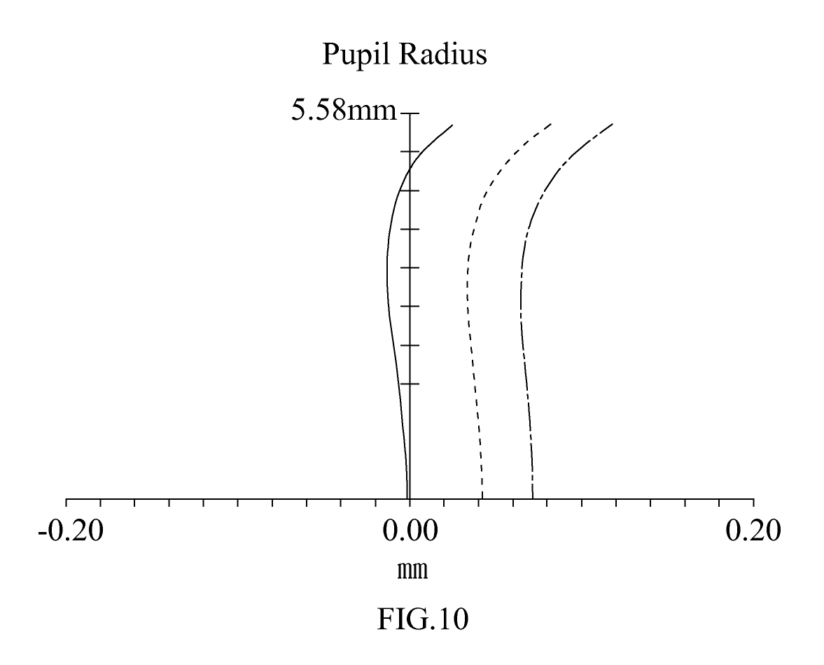

FIG. 7 is a schematic view showing the optical path structure of the projection lens system 1 according to a second embodiment of the present invention; FIG. 8 is a field curvature diagram of the projection lens system 1 in the second embodiment; FIG. 9 is a distortion diagram of the projection lens system 1 in the second embodiment; and FIG. 10 is a longitudinal aberration diagram of the projection lens system 1 in the second embodiment. In these figures, the corresponding vertical axes represent the radius height of the aperture stop.

In the Table 3 listed below, there are shown sequentially numbered optical surfaces from the screen 18 to the light valve 19; the radii of curvature R of these optical surfaces on the optical axis Z in mm; the on-axis surface spacing d between the adjacent optical surfaces on the optical axis Z; the refractive index N_{d} of each of the objects; the Abbe's number (v_{d}) of each the objects; and the effective focal length f, the field of view (FOV), and the f number (Fₙₒ) of the projection lens system 1.

TABLE 3
Optical Parameters in the Second Embodiment
f = 20.347 FOV = 30.49 Fno = 2.8815

| | | | Spacing d | Refractive | Abbe's |
|---|---|---|---|---|---|
| Optical Surface | | Radius R | (mm) | index N_{d} | number ν_{d} |
| 1 | Screen | ∞ | 605.000 | | |
| 2 | R1 | 8.011 | 1.751 | 1.59 | 61.16 |
| 3 | R2 | 136.402 | 0.043 | | |
| 4 | STOP | ∞ | 5.544 | | |
| 5 | R3 | −7.144 | 0.750 | 1.70 | 30.05 |
| 6 | R4 | 11.230 | 1.768 | | |
| 7 | R5 | −82.268 | 4.444 | 1.59 | 61.16 |
| 8 | R6 | −9.803 | 0.025 | | |
| 9 | R7* | 14.847 | 3.943 | 1.59 | 61.16 |
| 10 | R8* | −38.032 | 1.800 | | |
| 11 | R9 | ∞ | 13.500 | 1.65 | 33.85 |
| 12 | R10 | ∞ | 0.250 | | |
| 13 | R11 | ∞ | 0.750 | 1.52 | 63.69 |
| 14 | R12 | ∞ | 0.100 | | |
| 15 | Light valve | ∞ | | | |

*Aspherical Surface

In the Table 4 listed below, there are shown the coefficients for the aspheric surface formula (10) of the aspheric optical surfaces in the second embodiment:

TABLE 4
Aspheric Coefficients in the Second Embodiment

| Optical Surface | K | α₁ | α₂~α₈ |
|---|---|---|---|
| R7* | 0.0000E+00 | 2.4398E−03 | 0.0000E+00 |
| R8* | 0.0000E+00 | −8.7558E−05 | 0.0000E+00 |

Please refer to FIGS. 7 through 10 and Tables 3 to 4 along with FIG. 1. In the second embodiment, the first lens element 11 is made of a glass material having a refractive index N_{d1} of 1.59 and an Abbe's number v_{d1} of 61.16; the second lens element 13 is made of a glass material having a refractive index N_{d2} of 1.70 and an Abbe's number v_{d2} of 30.05; the third lens element 14 is made of a glass material having a refractive index N_{d3} of 1.59 and an Abbe's number v_{d3} of 61.16; and the fourth lens element 15 is made of a glass material having a refractive index N_{d4} of 1.59 and an Abbe's number v_{d4} of 61.16. In the second embodiment, the beam splitter 16 is a prism PBS made of a glass material having a refractive index N_{d5} of 1.65 and an Abbe's number v_{d5} of 33.85; and the cover glass 17 is made of a glass material having a refractive index N_{d6} of 1.52 and an Abbe's number v_{d6} of 63.69.

In the second embodiment of the projection lens system 1, the effective focal length f is 20.347 mm, the back focal length BFL is 16.41 mm, TL is 18.268 mm, L_{IN} is 11.176 mm, OH is 330.448 mm, and OD is 605 mm. The focal length F₁ of the first lens element 11 is 14.374 mm, and the composed focal length fₛ of the second lens group is 26.945 mm. The average refractive index N_{dave} and the average Abbe's number v_{dave} of the first lens element 11, the second lens element 13, the third lens element 14, and the fourth lens element 15 are 1.62 and 53.38, respectively. The refractive index N_{dPBS} and the Abbe's number V_{dPBS} of the PBS are 1.65 and 33.85, respectively.

After calculation, the values of the inequalities (1)˜(9) obtained from the second embodiment of the projection lens system 1 are shown in the following Table 5. As can be seen from Table 5, the projection lens system 1 in the second embodiment thereof satisfies the conditions defined by the inequalities (1)˜(9).

TABLE 5
Values of the Inequalities (1)~(9)
Obtained from the Second Embodiment

| | |
|---|---|
| BFL/TL | 0.90 |
| TL/L_{LV} | 1.63 |
| OH/OD | 0.55 |
| f/BFL | 1.24 |
| f₁/fₛ | 0.53 |
| N_{dave} | 1.62 |
| ν_{dave} | 53.38 |
| N_{dPBS} | 1.65 |
| ν_{dPBS} | 33.85 |

In addition, the projection lens system 1 of the second embodiment can be applied to a projection apparatus 2 shown in FIG. 2. Since the projection apparatus 2 in the second embodiment includes elements and descriptions thereof all the same as those in the first embodiment, they are not discussed repeatedly herein.

By analyzing FIG. 7 and the field curvature diagram (FIG. 8), the distortion diagram (FIG. 9), and the longitudinal aberration diagram (FIG. 10), it is ascertained the second embodiment has effectively reduced the relative length of the projection lens system and provides widened field of view, and also enables the projection apparatus of the present invention to have a reduced size.

### Third Embodiment

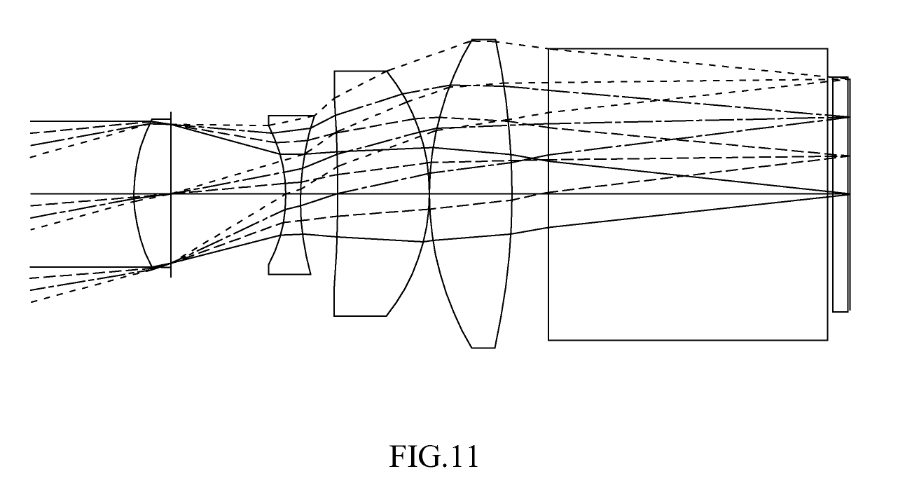

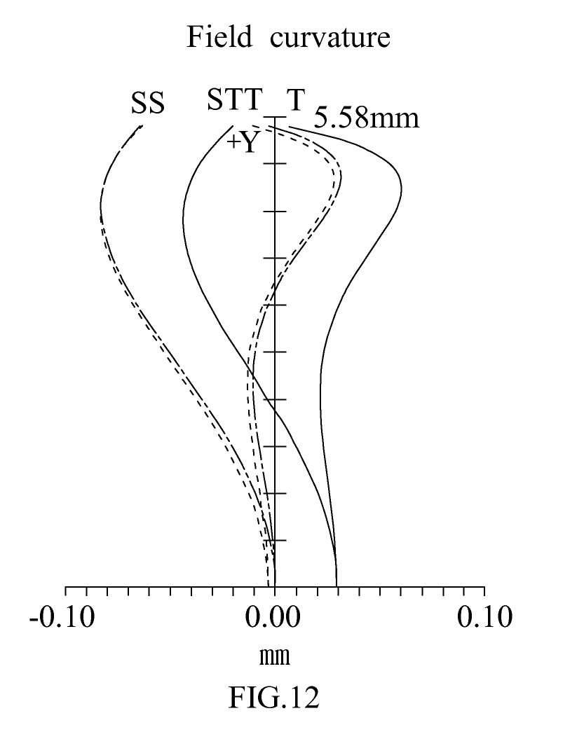

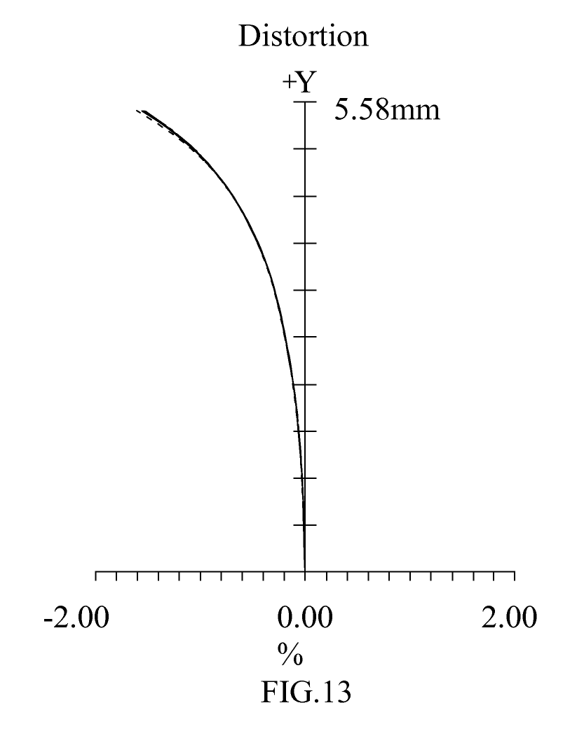

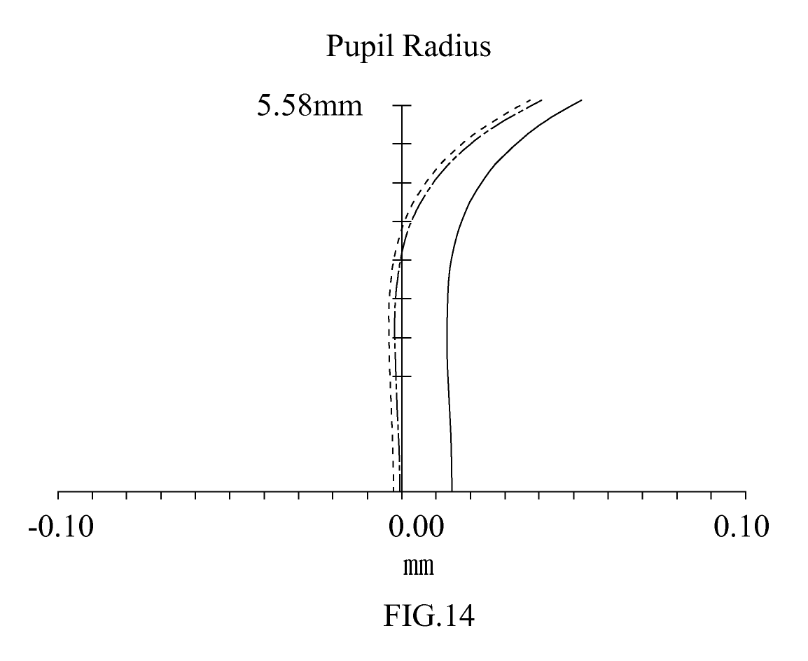

FIG. 11 is a schematic view showing the optical path structure of the projection lens system 1 according to a third embodiment of the present invention; FIG. 12 is a field curvature diagram of the projection lens system 1 in the third embodiment; FIG. 13 is a distortion diagram of the projection lens system 1 in the third embodiment; and FIG. 14 is a longitudinal aberration diagram of the projection lens system 1 in the third embodiment. In these figures, the corresponding vertical axes represent the radius height of the aperture stop.

In the Table 6 listed below, there are shown sequentially numbered optical surfaces from the screen 18 to the light valve 19; the radii of curvature R of these optical surfaces on the optical axis Z in mm; the on-axis surface spacing d between the adjacent optical surfaces on the optical axis Z; the refractive index N_{d} of each of the objects; the Abbe's number (v_{d}) of each the objects; and the effective focal length f, the field of view (FOV), and the f number (Fₙₒ) of the projection lens system 1.

TABLE 6
Optical Parameters in the Third Embodiment
f = 20.245 FOV = 30.642 Fno = 2.865

| | | Radius of | Spacing d | Refractive | Abbe's |
|---|---|---|---|---|---|
| Optical Surface | | curvature R | (mm) | index N_{d} | number ν_{d} |
| 1 | Screen | ∞ | 600.000 | | |
| 2 | R1 | 7.936 | 1.787 | 1.55 | 63.33 |
| 3 | R2 | 181.439 | 0.098 | | |
| 4 | STOP | ∞ | 5.618 | | |
| 5 | R3 | −7.182 | 0.750 | 1.70 | 30.05 |
| 6 | R4 | 11.800 | 1.691 | | |
| 7 | R5 | −95.246 | 4.501 | 1.59 | 61.16 |
| 8 | R6 | −9.823 | 0.025 | | |
| 9 | R7* | 14.753 | 3.990 | 1.59 | 61.16 |
| 10 | R8* | −38.737 | 1.911 | | |
| 11 | R9 | ∞ | 13.647 | 1.65 | 33.85 |
| 12 | R10 | ∞ | 0.250 | | |
| 13 | R11 | ∞ | 0.750 | 1.52 | 63.69 |
| 14 | R12 | ∞ | 0.100 | | |
| 15 | Light valve | ∞ | | | |

*Aspherical Surface

In the Table 7 listed below, there are shown the coefficients for the aspheric surface formula (10) of the aspheric optical surfaces in the third embodiment:

TABLE 7
Aspheric Coefficients in the Third Embodiment

| Optical surface | K | α₁ | α₂~α₈ |
|---|---|---|---|
| R7* | 0.0000E+00 | 1.5562E−03 | 0.0000E+00 |
| R8* | 0.0000E+00 | 1.3187E−03 | 0.0000E+00 |

Please refer to FIGS. 11 through 14 and Tables 6 to 7 along with FIG. 1. In the third embodiment, the first lens element 11 is made of a glass material having a refractive index N_{d1} of 1.55 and an Abbe's number v_{d1} of 63.33; the second lens element 13 is made of a glass material having a refractive index N_{d2} of 1.70 and an Abbe's number v_{d2} of 30.05; the third lens element 14 is made of a glass material having a refractive index N_{d3} of 1.59 and an Abbe's number v_{d3} of 61.16; and the fourth lens element 15 is made of a glass material having a refractive index N_{d4} of 1.59 and an Abbe's number v_{d4} of 61.16. In the third embodiment, the beam splitter 16 is a prism PBS made of a glass material having a refractive index N_{d5} of 1.65 and an Abbe's number v_{d5} of 33.85; and the cover glass 17 is made of a glass material having a refractive index N_{d6} of 1.52 and an Abbe's number v_{d6} of 63.69.

In the third embodiment of the projection lens system 1, the effective focal length f is 20.2451 mm, the back focal length BFL is 16.658 mm, TL is 18.460 mm, L_{IN} is 11.176 mm, OH is 332.237 mm, and OD is 600 mm. The focal length F₁ of the first lens element 11 is 14.364 mm, and the composed focal length fₛ of the second lens group is 26.025 mm. The average refractive index N_{dave} and the average Abbe's number v_{dave} of the first lens element 11, the second lens element 13, the third lens element 14, and the fourth lens element 15 are 1.61 and 53.93, respectively. The refractive index N_{dPBS} and the Abbe's number V_{dPBs} of the PBS are 1.65 and 33.85, respectively.

After calculation, the values of the inequalities (1)˜(9) obtained from the third embodiment of the projection lens system 1 are shown in the following Table 8. As can be seen from Table 8, the projection lens system 1 in the third embodiment thereof satisfies the conditions defined by the inequalities (1)˜(9).

TABLE 8
Values of the Inequalities (1)~(9)
Obtained from the Third Embodiment

| | |
|---|---|
| BFL/TL | 0.90 |
| TL/L_{LV} | 1.65 |
| OH/OD | 0.55 |
| f/BFL | 1.22 |
| f₁/fₛ | 0.55 |
| N_{dave} | 1.61 |
| ν_{dave} | 53.93 |
| N_{dPBS} | 1.65 |
| ν_{dPBS} | 33.85 |

In addition, the projection lens system 1 of the third embodiment can be applied to a projection apparatus 2 shown in FIG. 2. Since the projection apparatus 2 in the third embodiment includes elements and descriptions thereof all the same as those in the first embodiment, they are not discussed repeatedly herein.

By analyzing FIG. 11 and the field curvature diagram (FIG. 12), the distortion diagram (FIG. 13), and the longitudinal aberration diagram (FIG. 14), it is ascertained the third embodiment has effectively reduced the relative length of the projection lens system and provides widened field of view, and also enables the projection apparatus of the present invention to have a reduced size.

### Fourth Embodiment

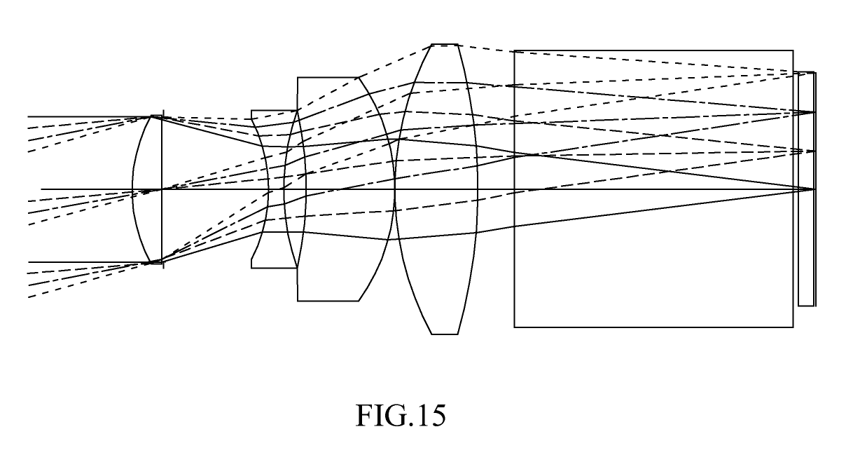

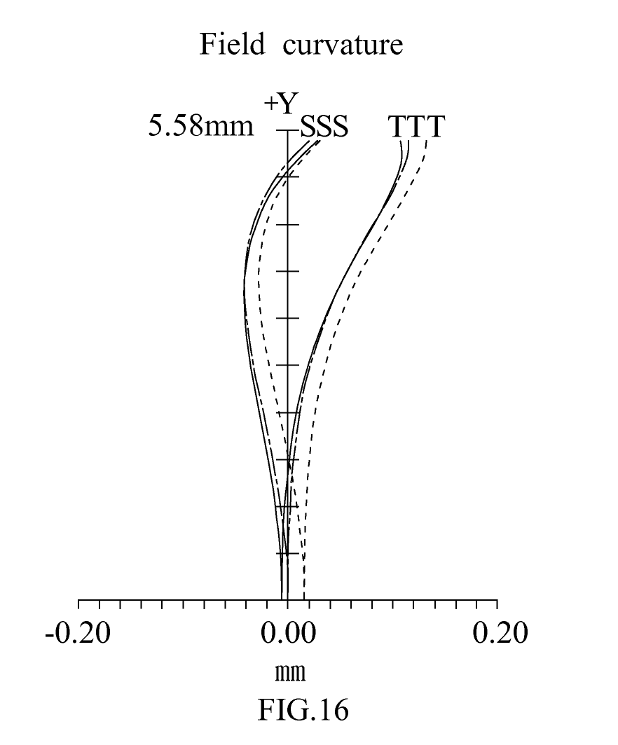

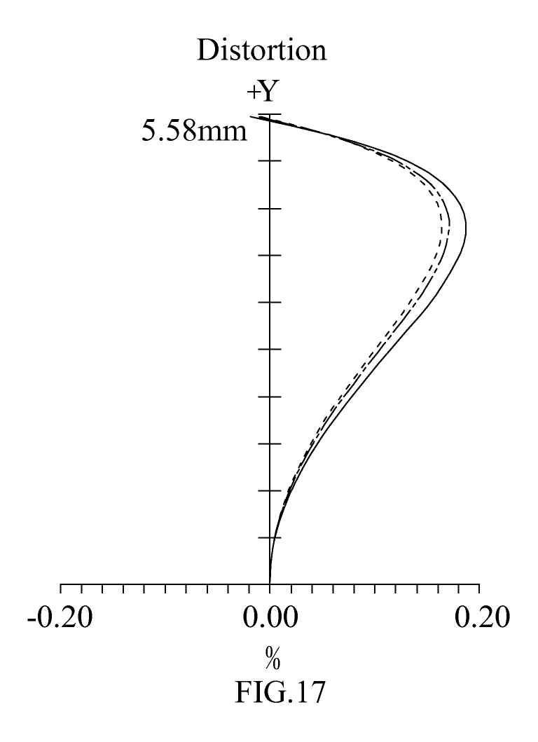

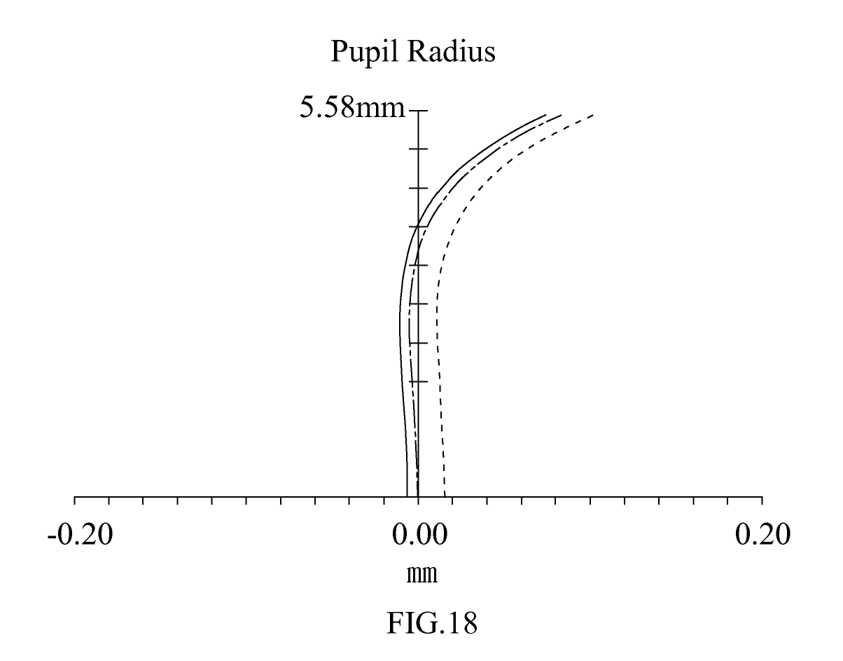

FIG. 15 is a schematic view showing the optical path structure of the projection lens system 1 according to a fourth embodiment of the present invention; FIG. 16 is a field curvature diagram of the projection lens system 1 in the fourth embodiment; FIG. 17 is a distortion diagram of the projection lens system 1 in the fourth embodiment; and FIG. 18 is a longitudinal aberration diagram of the projection lens system 1 in the fourth embodiment. In these figures, the corresponding vertical axes represent the radius height of the aperture stop.

In the Table 9 listed below, there are shown sequentially numbered optical surfaces from the screen 18 to the light valve 19; the radii of curvature R of these optical surfaces on the optical axis Z in mm; the on-axis surface spacing d between the adjacent optical surfaces on the optical axis Z; the refractive index N_{d} of each of the objects; the Abbe's number (v_{d}) of each the objects; and the effective focal length f, the field of view (FOV), and the f number (Fₙₒ) of the projection lens system 1.

TABLE 9
Optical Parameters in the Fourth Embodiment
f = 19.521 FOV = 31.656 Fno = 2.77

| | | Radius of | Spacing d | Refractive | Abbe's |
|---|---|---|---|---|---|
| Optical Surface | | curvature R | (mm) | index N_{d} | number ν_{d} |
| 1 | Screen | ∞ | 605.000 | | |
| 2 | R1 | 7.697 | 1.444 | 1.55 | 63.33 |
| 3 | R2 | −1121.358 | 0.032 | | |
| 4 | STOP | ∞ | 5.130 | | |
| 5 | R3 | −7.405 | 0.750 | 1.70 | 30.05 |
| 6 | R4 | 11.790 | 1.093 | | |
| 7 | R5 | −17.781 | 4.275 | 1.59 | 61.27 |
| 8 | R6 | −9.062 | 0.025 | | |
| 9 | R7* | 40.952 | 3.999 | 1.59 | 61.27 |
| 10 | R8* | −31.129 | 1.757 | | |
| 11 | R9 | ∞ | 13.494 | 1.52 | 64.17 |
| 12 | R10 | ∞ | 0.250 | | |
| 13 | R11 | ∞ | 0.750 | 1.52 | 63.69 |
| 14 | R12 | ∞ | 0.100 | | |
| 15 | Light valve | ∞ | | | |

*Aspherical Surface

In the Table 10 listed below, there are shown the coefficients for the aspheric surface formula (10) of the aspheric optical surfaces in the fourth embodiment:

TABLE 10
Aspheric Coefficients in the Fourth Embodiment

| Optical surface | K | α₁ | α₂~α₈ |
|---|---|---|---|
| R7* | 0.0000E+00 | 2.4104E−02 | 0.0000E+00 |
| R8* | 0.0000E+00 | −3.7586E−03 | 0.0000E+00 |

Please refer to FIGS. 15 through 18 and Tables 9 to 10 along with FIG. 1. In the fourth embodiment, the first lens element 11 is made of a glass material having a refractive index N_{d1} of 1.55 and an Abbe's number v_{d1} of 63.33; the second lens element 13 is made of a glass material having a refractive index N_{d2} of 1.70 and an Abbe's number v_{d2} of 30.05; the third lens element 14 is made of a glass material having a refractive index N_{d3} of 1.59 and an Abbe's number v_{d3} of 61.27; and the fourth lens element 15 is made of a glass material having a refractive index N_{d4} of 1.59 and an Abbe's number v_{d4} of 61.27. In the fourth embodiment, the beam splitter 16 is a prism PBS made of a glass material having a refractive index N_{d5} of 1.52 and an Abbe's number v_{d5} of 64.17; and the cover glass 17 is made of a glass material having a refractive index N_{d6} of 1.52 and an Abbe's number v_{d6} of 63.69. The refractive index N_{dPBS} and the Abbe's number V_{dPBS} of the PBS are 1.52 and 64.17, respectively.

In the fourth embodiment of the projection lens system 1, the effective focal length f is 19.521 mm, the back focal length BFL is 16.352 mm, TL is 16.747 mm, L_{LV} is 11.176 mm, OH is 343.62 mm, and OD is 605 mm. The focal length F₁ of the first lens element 11 is 13.843 mm, and the composed focal length fₛ of the second lens group is 30.688 mm. The average refractive index N_{dave} and the average Abbe's number v_{dave} of the first lens element 11, the second lens element 13, the third lens element 14, and the fourth lens element 15 are 1.61 and 53.98, respectively.

After calculation, the values of the inequalities (1)˜(9) obtained from the fourth embodiment of the projection lens system 1 are shown in the following Table 11. As can be seen from Table 11, the projection lens system 1 in the third embodiment thereof satisfies the conditions defined by the inequalities (1)˜(9).

TABLE 11
Values of the Inequalities (1)~(9)
Obtained from the Fourth Embodiment

| | |
|---|---|
| BFL/TL | 0.98 |
| TL/L_{LV} | 1.50 |
| OH/OD | 0.57 |
| f/BFL | 1.19 |
| f₁/fₛ | 0.45 |
| N_{dave} | 1.61 |
| ν_{dave} | 53.98 |
| N_{dPBS} | 1.52 |
| ν_{dPBS} | 64.17 |

In addition, the projection lens system 1 of the fourth embodiment can be applied to a projection apparatus 2 shown in FIG. 2. Since the projection apparatus 2 in the fourth embodiment includes elements and descriptions thereof all the same as those in the first embodiment, they are not discussed repeatedly herein.

By analyzing FIG. 15 and the field curvature diagram (FIG. 16), the distortion diagram (FIG. 17), and the longitudinal aberration diagram (FIG. 18), it is ascertained the fourth embodiment has effectively reduced the relative length of the projection lens system and provides widened field of view, and also enables the projection apparatus of the present invention to have a reduced size.

### Fifth Embodiment

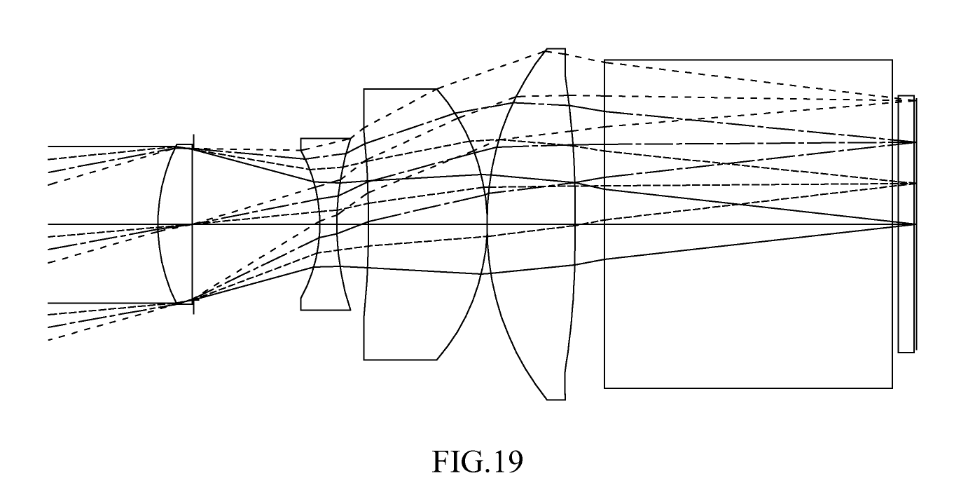

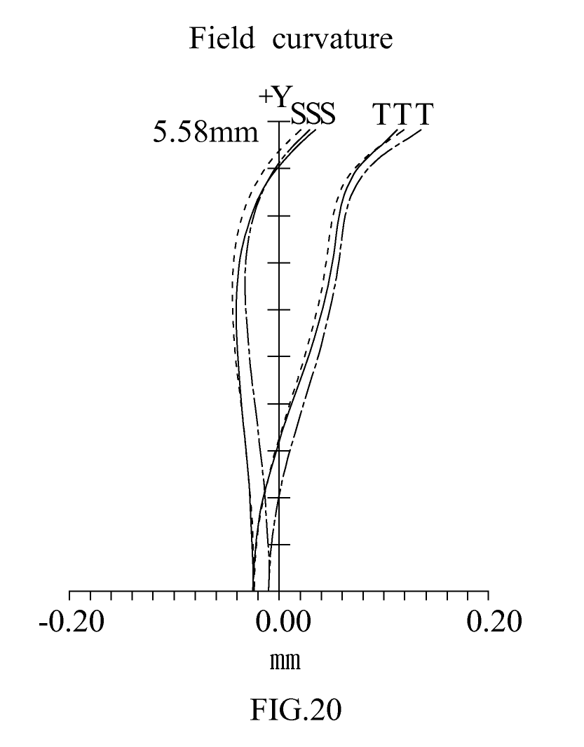

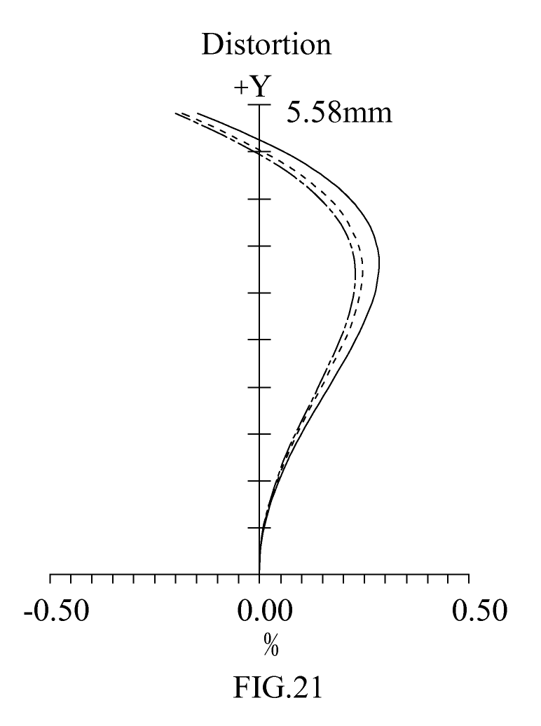

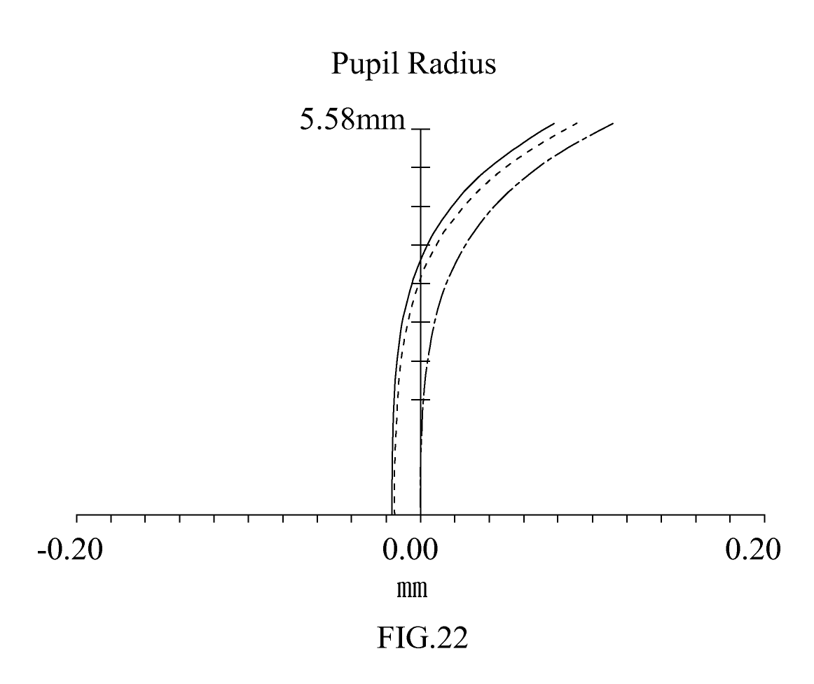

FIG. 19 is a schematic view showing the optical path structure of the projection lens system 1 according to a fifth embodiment of the present invention; FIG. 20 is a field curvature diagram of the projection lens system 1 in the fifth embodiment; FIG. 21 is a distortion diagram of the projection lens system 1 in the fifth embodiment; and FIG. 22 is a longitudinal aberration diagram of the projection lens system 1 in the fifth embodiment. In these figures, the corresponding vertical axes represent the radius height of the aperture stop.

In the Table 12 listed below, there are shown sequentially numbered optical surfaces from the screen 18 to the light valve 19; the radii of curvature R of these optical surfaces on the optical axis Z in mm; the on-axis surface spacing d between the adjacent optical surfaces on the optical axis Z; the refractive index N_{d} of each of the objects; the Abbe's number (v_{d}) of each the objects; and the effective focal length f, the field of view (FOV), and the f number (Fₙₒ) of the projection lens system 1.

TABLE 12
Optical Parameters in the Fifth Embodiment
f = 19.826 FOV = 31.362 Fno = 2.8025

| | | Radius of | Spacing d | Refractive | Abbe's |
|---|---|---|---|---|---|
| Optical Surface | | curvature R | (mm) | index N_{d} | number ν_{d} |
| 1 | SCREEN | ∞ | 605.000 | | |
| 2 | R1 | 8.028 | 1.540 | 1.59 | 61.16 |
| 3 | R2 | 174.968 | 0.079 | | |
| STOP | | ∞ | 5.752 | | |
| 4 | R3 | −6.999 | 0.750 | 1.70 | 30.05 |
| 5 | R4 | 11.926 | 1.478 | | |
| 6 | R5 | −42.659 | 5.381 | 1.59 | 61.16 |
| 7 | R6 | −9.326 | 0.025 | | |
| 8 | R7* | 14.329 | 4.000 | 1.59 | 61.16 |
| 9 | R8* | −42.853 | 1.329 | | |
| 10 | R9 | ∞ | 13.104 | 1.65 | 33.85 |
| 11 | R10 | ∞ | 0.250 | | |
| 12 | R11 | ∞ | 0.750 | 1.52 | 63.69 |
| 13 | R12 | ∞ | 0.100 | | |
| 14 | IMA | ∞ | | | |

*Aspherical Surface

In the Table 13 listed below, there are shown the coefficients for the aspheric surface formula (10) of the aspheric optical surfaces in the fifth embodiment:

TABLE 13
Aspheric Coefficients in the Fifth Embodiment

| Optical | | | | | | | | | |
|---|---|---|---|---|---|---|---|---|---|
| surface | K | αl | α2 | α3 | α4 | α5 | α6 | α7 | α8 |
| R7* | −3.9960E−01 | 3.9919E−03 | −2.0728E−05 | −2.2613E−07 | 6.9540E−10 | 4.2440E−11 | 1.2381E−12 | 2.1085E−14 | 0.0000E+00 |
| R8* | 4.9941E+00 | 3.1453E−03 | −9.1960E−06 | −8.7250E−07 | 2.6003E−09 | 1.1625E−10 | 1.5035E−12 | 1.6892E−14 | 0.0000E+00 |

Please refer to FIGS. 19 through 22 and Tables 12 to 13 along with FIG. 1. In the fifth embodiment, the first lens element 11 is made of a glass material having a refractive index N_{d1} of 1.59 and an Abbe's number v_{d1} of 61.16; the second lens element 13 is made of a glass material having a refractive index N_{d2} of 1.70 and an Abbe's number v_{d2} of 30.05; the third lens element 14 is made of a glass material having a refractive index N_{d3} of 1.59 and an Abbe's number v_{d3} of 61.16; and the fourth lens element 15 is made of a glass material having a refractive index N_{d4} of 1.59 and an Abbe's number v_{d4} of 61.16. In the fifth embodiment, the beam splitter 16 is a prism PBS made of a glass material having a refractive index N_{d5} of 1.65 and an Abbe's number v_{d5} of 33.85; and the cover glass 17 is made of a glass material having a refractive index N_{d6} of 1.52 and an Abbe's number v_{d6} of 63.69. The refractive index N_{dPBS} and the Abbe's number V_{dPBS} of the PBS are 1.52 and 64.17, respectively.

In the fifth embodiment of the projection lens system 1, the effective focal length f is 19.826 mm, the back focal length BFL is 15.533 mm, TL is 19.004 mm, L_{LV} is 11.176 mm, OH is 340.32 mm, and OD is 605 mm. The focal length F₁ of the first lens element 11 is 13.843 mm, and the composed focal length fₛ of the second lens group is 30.688 mm. The average refractive index N_{dave} and the average Abbe's number v_{dave} of the first lens element 11, the second lens element 13, the third lens element 14, and the fourth lens element 15 are 1.62 and 53.38, respectively.

After calculation, the values of the inequalities (1)˜(9) obtained from the fifth embodiment of the projection lens system 1 are shown in the following Table 14. As can be seen from Table 14, the projection lens system 1 in the third embodiment thereof satisfies the conditions defined by the inequalities (1)˜(9).

TABLE 14
Values of the Inequalities (1)~(9)
Obtained from the Fifth Embodiment

| | |
|---|---|
| BFL/TL | 0.82 |
| TL/L_{LV} | 1.70 |
| OH/OD | 0.57 |
| f/BFL | 1.28 |
| f₁/fₛ | 0.45 |
| N_{dave} | 1.62 |
| ν_{dave} | 53.38 |
| N_{dPBS} | 1.65 |
| ν_{dPBS} | 33.85 |

In addition, the projection lens system 1 of the fifth embodiment can be applied to a projection apparatus 2 shown in FIG. 2. Since the projection apparatus 2 in the fifth embodiment includes elements and descriptions thereof all the same as those in the first embodiment, they are not discussed repeatedly herein.

By analyzing FIG. 19 and the field curvature diagram (FIG. 20), the distortion diagram (FIG. 21), and the longitudinal aberration diagram (FIG. 22), it is ascertained the fifth embodiment has effectively reduced the relative length of the projection lens system and provides widened field of view, and also enables the projection apparatus of the present invention to have a reduced size.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A projection lens system for arranging between a screen and a light valve of a projection apparatus, comprising:
a first lens element with positive refractive power, a second lens element with negative refractive power, a third lens element with positive refractive power and a fourth lens element with positive refractive power arranged along an optical axis in order from the screen toward the light valve;
wherein the projection lens system satisfies the following condition:
0.79<BFL/TL<0.99
where, BFL is a back focal length of the projection lens system, and TL is an overall length from the screen side of the first lens element to the light-valve side of the fourth lens element on the optical axis of the projection lens system.

2. The projection lens system as claimed in claim 1, wherein the overall length of the projection lens system further satisfies the following condition:
1.47<TL/L_{Lv}<1.72
where, L_{LV} is the effective diagonal line length of the light valve, and TL is an overall length from the screen side of the first lens element to the light-valve side of the fourth lens element on the optical axis of the projection lens system.

3. The projection lens system as claimed in claim 1, wherein the projection lens system provides an image height satisfies the following condition:
0.52<OH/OD<0.59
where, OH is the image height of an image projected onto the screen by parallel light rays incident upon the projection lens system; and OD is a distance from the screen to the screen side of the first lens element on the optical axis.

4. The projection lens system as claimed in claim 1, wherein the projection lens system provides a back focal length satisfies the following condition:
1.1<f/BFL<1.29
where, f is an effective focal length of the projection lens system, and BFL is a back focal length of the projection lens system.

5. The projection lens system as claimed in claim 1, wherein the first lens element of the projection lens system has a focal length satisfies the following condition:
0.43<f₁/fₛ<0.65
where, f₁ is the focal length of the first lens element, and fₛ is a composed focal length of a second lens group; and
wherein the second lens group is formed from the second lens element, the third lens element and the fourth lens element.

6. The projection lens system as claimed in claim 1, wherein the projection lens system has an average refractive index N_{dave} satisfying the following condition:
1.58<N_{dave}<1.65
wherein, the average refractive index N_{dave} is an arithmetic mean of the refractive indexes of the first, second, third and fourth lens elements.

7. The projection lens system as claimed in claim 1, wherein the projection lens system has an average Abbe's number v_{dave} satisfying the following condition:
53.1<v_{dave}<56.8
wherein, the average Abbe's number N_{dave} is an arithmetic mean of the Abbe's numbers of the first, second, third and fourth lens elements.

8. The projection lens system as claimed in claim 1, wherein the first lens element is a planoconvex lens with the convex surface thereof facing toward the screen.

9. The projection lens system as claimed in claim 1, wherein the second lens element is a biconcave lens.

10. The projection lens system as claimed in claim 1, wherein the third lens element is a meniscus lens with the concave surface facing toward the screen.

11. The projection lens system as claimed in claim 1, wherein the fourth lens element is a biconvex lens.

12. The projection lens system as claimed in claim 1, further comprising an aperture stop arranged between the first lens element and the second lens element.

13. The projection lens system as claimed in claim 1, wherein each of the first lens element, the second lens element, the third lens element and the fourth lens element has a spherical surface at the screen side and a spherical surface at the light valve side.

14. The projection lens system as claimed in claim 1, wherein each of the first lens element, the second lens element and the third lens element has a spherical surface at the screen side and a spherical surface at the light valve side, and the fourth lens element has an aspheric surface at the screen side and an aspheric surface at the light valve side.

15. The projection lens system as claimed in claim 1, wherein the first lens element, the second lens element, the third lens element and the fourth lens element all are made of a glass material.

16. The projection lens system as claimed in claim 1, wherein the first lens element, the second lens element, the third lens element and the fourth lens element all are made of a plastic material.

17. The projection lens system as claimed in claim 1, wherein the projection lens system is a telecentric lens system.

18. A projection apparatus for projecting an image onto a screen, comprising:
a light source for emitting an illuminating beam;
a beam splitter for receiving the illumination beam from the light source;
a light valve for receiving the illuminating beam from the beam splitter and then creating an image beam; and
a projection lens system as claimed in claim 1 being arranged on a path of the image beam for receiving the image beam and projecting the same onto the screen.

19. The projection apparatus as claimed in claim 18, wherein the light valve has an effective diagonal line length satisfying the following condition:
1.47<TL/L_{LV}<1.72
where, L_{LV} is the effective diagonal line length of the light valve, and TL is an overall length from the screen side of the first lens element to the light-valve side of the fourth lens element on an optical axis of the projection lens system.

20. The projection apparatus as claimed in claim 18, wherein a distance between the screen and the screen side of the first lens element satisfies the following condition:
0.52<OH/OD<0.59
where, OH is an image height of an image projected onto the screen by parallel light rays incident upon the projection lens system; and OD is the distance from the screen to the screen side of the first lens element on the optical axis.

21. The projection apparatus as claimed in claim 18, wherein the projection lens system provides a back focal length satisfying the following condition:
1.1<f/BFL<1.29
where, f is an effective focal length of the projection lens system, and BFL is the back focal length of the projection lens system.

22. The projection apparatus as claimed in claim 18, wherein the first lens element of the projection lens system has a focal length satisfying the following condition:
0.43<f₁/fₛ<0.65
where, f₁ is the focal length of the first lens element, and f is the composed focal length of the second lens group; and
wherein the second lens group is formed from the second lens element, the third lens element and the fourth lens element.

23. The projection apparatus as claimed in claim 18, wherein the projection lens system has an average refractive index N_{dave} satisfying the following condition:
1.58<N_{dave}<1.65
wherein, the average refractive index N_{dave} is an arithmetic mean of the refractive indexes of the first, second, third and fourth lens elements.

24. The projection apparatus as claimed in claim 18, wherein the projection lens system has an average Abbe's number v_{dave} satisfying the following condition:
53.1<v_{dave}<56.8
wherein, the average Abbe's number v_{dave} is an arithmetic mean of the Abbe's numbers of the first, second, third and fourth lens elements.

25. The projection apparatus as claimed in claim 18, wherein the projection lens system is a lens system with telecentric.

26. The projection apparatus as claimed in claim 18, wherein the light valve is a liquid crystal on silicon (LCOS) display.

27. The projection apparatus as claimed in claim 18, wherein the beam splitter is a polarization beam splitter.

28. The projection apparatus as claimed in claim 27, wherein the polarization beam splitter is a prism polarization beam splitter (PBS).

29. The projection apparatus as claimed in claim 28, wherein the polarization beam splitter in the form of a prism PBS satisfies the following conditions:
1.62<N_{dPBS}<1.67; and
33.6<v_{dPBS}<64.3;
where, N_{dPBS} and V_{dPBS} are the refractive index and the Abbe's number, respectively, of the prism PBS.

30. The projection apparatus as claimed in claim 18, wherein the beam splitter is a non-polarization beam splitter.
